(19) United States
(12) Patent Application Publication
(10) Pub. No.: US 2008/0281902 A1
(43) Pub. Date: Nov. 13, 2008

(54) System and Method for Providing Improved Communication Notification Forwarding on a Network

(76) Inventors: David L. Kaminsky, Chapel Hill, NC (US); Mudit Mehrotra, Haryana (IN); David M. Ogle, Cary, NC (US)

Correspondence Address: DILLON & YUDELL LLP, 8911 N. CAPITAL OF TEXAS HWY., SUITE 2110, AUSTIN, TX, 78759, US

(21) Appl. No.: 11/745,754

(22) Filed: May 8, 2007

(51) Int. Cl. G06F 15/16

(52) U.S. Cl. 709/203

(57) ABSTRACT

A system and method for improved communication notification forwarding on a network. An instant messaging (IM) server program receives at least one communication notification from a first client among a collection of clients on a network, wherein the at least one communication notification is targeted to a second client among the collection of clients. A notification manager compares a current network performance level to a predetermined threshold. In response to said comparing the current network performance level to the predetermined threshold, the notification manager parses a first list to determine if a first user indicator associated with said first client is present on the first list, wherein the first list indicates a first collection of user indicators of clients from which communication notifications are to be forwarded as high priority communication notifications. If the user indicator associated with the first client is present on the first list, the IM server program forwards the at least one communication notification as a high priority communication notification to said second client.

### BACKGROUND OF THE INVENTION

1. Technical Field

The present invention relates in general to the field of data processing systems and in particular, the field of processing data within data processing systems. Still more particularly, the present invention relates to providing timely data updates within data processing systems.

2. Description of the Related Art

In computer and telecommunications networks, “user status indicators” present a user's status regarding that user's ability and willingness to communicate over the network. Since the user's status may change frequently, depending on the user's current activity, user status indicators need to be updated with “presence information updates” to accurately depict the user's current status. As well-known in the art, a user's e-mail or instant messaging client provides presence information updates by connecting via a network to a presence service that is usually hosted by a server.

The use of the Internet has transformed the global economy by changing the way individuals and entities communicate. Instead of sending a traditional letter or placing a telephone call, more and more individuals are taking advantage of e-mail and instant messaging (IM). Frequently, businesses prefer that their customers utilize an e-mail or IM client for inquiries. IM clients utilize presence information to indicate to other users of the same IM system the user state of a particular user (e.g., whether the user is in an “available”, “do not disturb”, “offline”, etc. state). The use of user status indicators enables other users to send messages when the user desires the receipt of messages.

Some more recent uses of presence information include inserting and updating user status indicators in web pages and web-based e-mail services, like Yahoo!®, Google®, and MSN®. With the increased use of user status indicators, presence services are becoming overloaded with the constant presence information updates required to ensure that the user status indicators accurately depict the user's present status. Current presence services deal with the increased workload by either: (1) adding more servers and/or bandwidth to handle the increased workload; or (2) begin dropping messages and/or presence information updates when the system becomes overloaded. Both of these current solutions are undesirable.

Adding more servers and/or bandwidth is a temporary solution since only so many servers and/or so much bandwidth can be added until the complexity and cost of the system becomes prohibitive. Dropping messages means that there is no way of knowing for sure that a message has been sent and received by the recipient unless the recipient replies with a message of his/her own. Dropping presence information updates results in a longer and longer delay between presence information updates. Long delay between presence information updates erodes the usefulness of even having user status indicators because the user's present status may not be accurately depicted. If other users cannot accurately determine the status of a particular user due to an outdated user status indicator state, the user status indicator has limited usefulness. Therefore, there is a need for a system and method for overcoming the aforementioned limitations of the prior art.

### SUMMARY OF THE INVENTION

A system and method for improved communication notification forwarding on a network. An instant messaging (IM) server program receives at least one communication notification from a first client among a collection of clients on a network, wherein the at least one communication notification is targeted to a second client among the collection of clients. A notification manager compares a current network performance level to a predetermined threshold. In response to comparing the current network performance level to the predetermined threshold, the notification manager parses a first list to determine if a first user indicator associated with said first client is present on the first list, wherein the first list indicates a first collection of user indicators of clients from which communication notifications are to be forwarded as high priority communication notifications. If the user indicator associated with the first client is present on the first list, the IM server program forwards the at least one communication notification as a high priority communication notification to said second client.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1A is a block diagram illustrating an exemplary network in which an embodiment of the present invention may be implemented;

FIG. 1B is a block diagram depicting an exemplary data processing system in which an embodiment of the present invention may be implemented;

FIG. 2A is a block diagram illustrating exemplary contents of system memory within a gateway server according to an embodiment of the present invention;

FIG. 2B is a block diagram depicting exemplary contents of system memory within a client according to an embodiment of the present invention;

FIG. 3 is a block diagram illustrating an instant messaging (IM) contact list and chat window according to an embodiment of the present invention; and

FIG. 4 is a high-level logical flowchart depicting an exemplary method for providing improved communication notification forwarding on a network according to an embodiment of the present invention.

### DETAILED DESCRIPTION OF AN ILLUSTRATIVE EMBODIMENT

A system and method for improved communication notification forwarding on a network. An instant messaging (IM) server program receives at least one communication notification from a first client among a collection of clients on a network, wherein the at least one communication notification is targeted to a second client among the collection of clients. A notification manager compares a current network traffic to a predetermined threshold. In response to comparing the current network performance level to the predetermined threshold, the notification manager parses a first list to determine if a first user indicator associated with said first client is present on the first list, wherein the first list indicates a first collection of user indicators of clients from which communication notifications are to be forwarded as high priority communication notifications. If the user indicator associated with the first client is present on the first list, the IM server program forwards the at least one communication notification as a high priority communication notification to said second client.

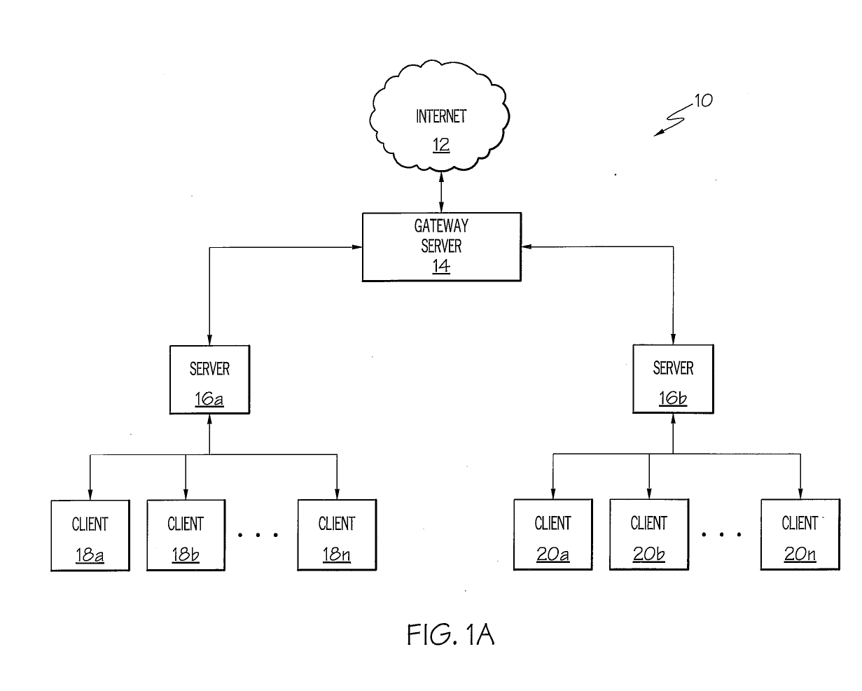

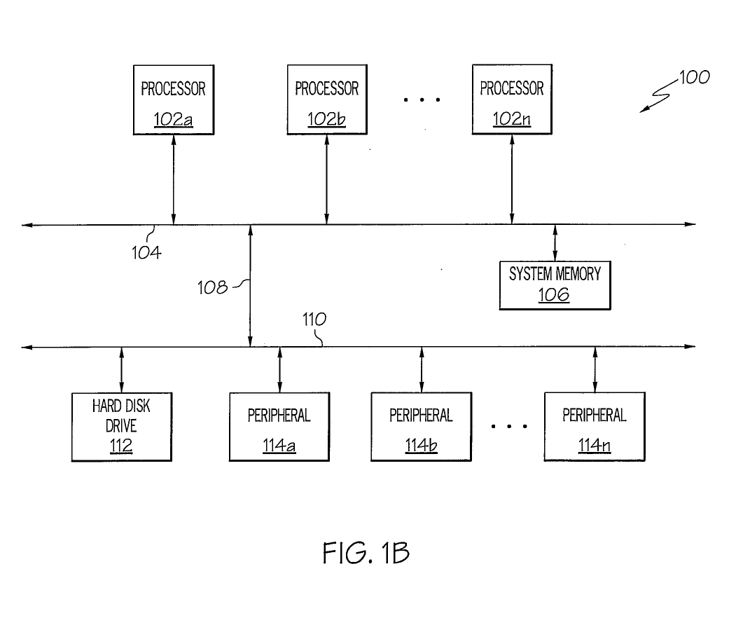

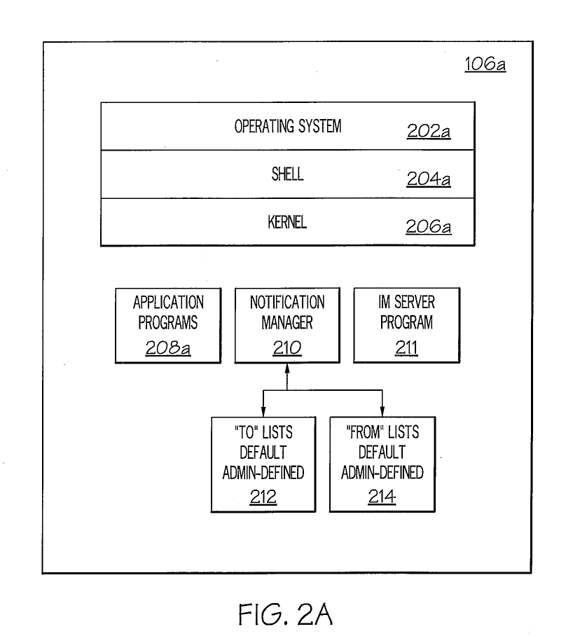

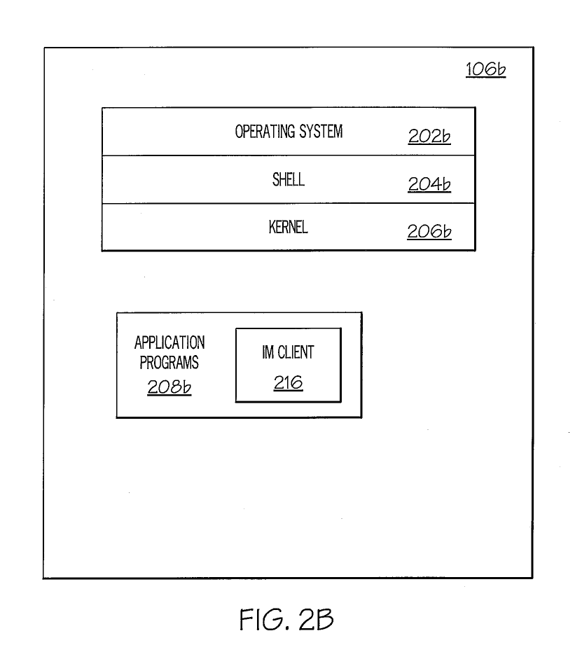

Generally, FIGS. 1, 2, and 3 depict a system that implements an instant messaging (IM) service. According to an embodiment of the present invention, gateway server 14 (FIG. 1A), which includes system memory 106a (FIG. 2A), stores an IM server program 211 (FIG. 2A) within system memory 106a (FIG. 2A). IM server program 211 enables clients 18a-18n (FIG. 1A) and clients 20a-20n (FIG. 1A), which both include system memory 106b (FIG. 2B), to communicate with each other with communication notifications in the form of messages via IN client 216 (FIG. 2B) stored in system memory 106b.

IM client 216 (FIG. 2B) enables clients 18a-18n and clients 20a-20n to send messages to each other. Also, if the user state of users accessing clients 18a-18n and clients 20a-20n change (e.g., online-to-offline state, etc.), NM client 216 sends a communication notification in the form of a presence information update to other clients on the network. The presence information updates are first sent to IN server program 211, which forwards the presence information updates to the intended client recipients depending on instructions from a notification manager 210 (FIG. 2A). The presence information updates enable clients on the network to determine the current user state of the other clients on the network. Notification manager 210 examines the current network performance level and the contents of “To” lists 212 and “From” lists 214 to determine whether or not communication notifications received by IM server program 211 are forwarded to the intended recipients.

FIG. 1A illustrates an exemplary network 10 in which another embodiment of the present invention may be implemented. As depicted, exemplary network 10 includes Internet 12, gateway server 14, servers 16a-16b, clients 18a-18n, and clients 20a-20n. Server 26a and clients 28a-28n represent a first sub-network and server 26b and clients 20a-20n represent a second sub-network. In an embodiment of the present invention, the first sub-network may represent the computer network of a first company and the second sub-network may represent the computer network of a second company. Frequently, after two companies merge, the companies must merge their computer networks via gateway server 14, which controls traffic between the two sub-networks and Internet 12. Those with skill in the art will appreciate that the present invention contemplates any number of gateway servers and sub-networks of any configuration and does not limit the network configuration to one gateway server and two sub-networks. Also, those with skill in the art will appreciate that the present invention contemplates networks of any topography and is in no way limited to the configuration depicted in FIG. 1A.

FIG. 1B is a block diagram depicting an exemplary data processing system 100 that may be utilized to implement gateway server 14, servers 16a-16b, clients 18a-18n, and/or clients 20a-20n in accordance with the present invention. As illustrated, data processing system 100 includes a collection of processors 102a-102n, which are coupled to system memory 104 via system bus 104. Mezzanine bus 108 couples peripheral bus 110 to system bus 104. Peripheral bus 110 couples a hard disk drive 112, utilized as a mass storage device, and a collection of peripherals 114a-114n. Those with skill in the art will appreciate that peripherals 114a-114n may include, but are not limited to, network adapters, optical drives, flash drives, etc. Those with skill in the art will appreciate that data processing system 100 can include many additional components not specifically illustrated in FIG. 1B. Because such additional components are not necessary for an understanding of the present invention, they are not illustrated in FIG. 1B or discussed further herein. It should be understood that the enhancements to data processing system 100 provided by the present invention are applicable to data processing systems of any system architecture and are in no way limited to the generalized multiprocessor architecture illustrated in FIG. 1B.

FIGS. 2A and 2B are block diagrams illustrating exemplary contents of system memories 106a-106b. System memory 106a represents the system memory for gateway server 14 (FIG. 1A), while system memory 106b represents the system memory for clients 18a-18n and clients 20a-20n according to an embodiment of the present invention. As shown in both FIGS. 2A and 2B, system memories 106a-106b include operating systems 202a-202b, which further include shells 204a-204n (as they are called in UNIX®) for providing transparent user access to resources such as application programs 208a-208b. Generally, shells 204a-204b, also called command processors in Windows®, are generally the highest level of the operating system software hierarchy and serve as command interpreters. Shells 204a-204b provide system prompts, interpret commands entered by keyboard, mouse, or other user input media, and sends the interpreted command(s) to the appropriate lower levels of the operating systems (e.g., kernels 206a-206b) for processing. Note that while shells 204a-204b are text-based, line-oriented user interfaces, the present invention will support other user interface modes, such as graphical, voice, gestural, etc. equally well.

As illustrated, operating systems 202a-202b also include kernels 206a-206b. Kernels 206a-206b provide lower levels of functionality for operating systems 202a-202b and application programs 208a-208b, including memory management, process and task management, disk management, and mouse and keyboard management.

Referring to FIG. 2A, system memory 106a includes notification manager 210, IM server program 211, “To” lists 212, and “From” lists 214. IM server program 211 is a program that facilities the delivery of communication notifications (e.g., presence information updates and message) to and from clients 18a-18n and clients 20a-20n. IM server program 211 receives communication notifications and based on instructions from notification manager 210, IM server program 211 forwards the communication notifications.

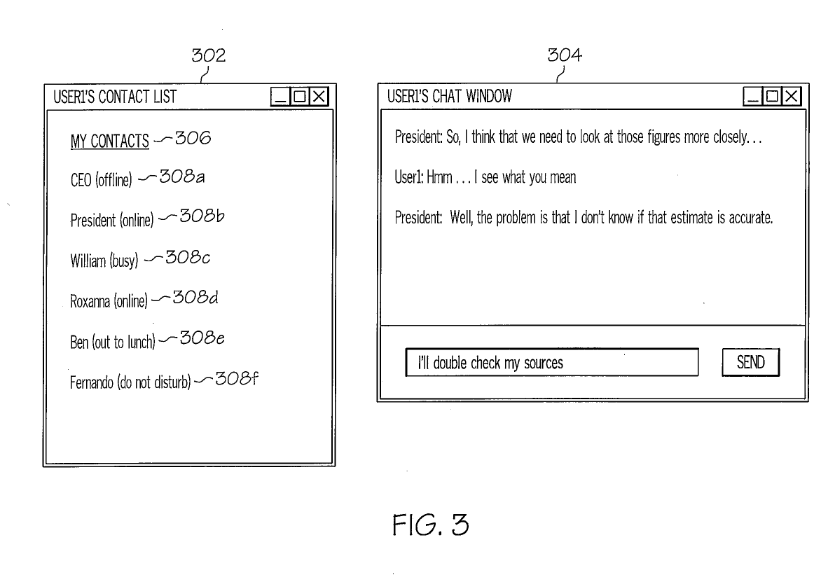

For instance, if a first user accesses an IM service via IM client 216 (FIG. 2B) stored in system memory 106b (FIG. 2B) of client 18a (FIG. 18a), the first user may perform actions (e.g., changing the user's status) that require presence information updates to ensure that a displayed user status indicator correctly displays the user's current status. For example, the user may sign-off the IM service, which requires that all other users that have added the first user to their respective contact lists (e.g., IM contact list 302, FIG. 3) receive a presence information update that indicates that the user has signed off. IM client 216 sends a presence information update to EM server program 211. Notification manager 210 examines a current network performance level. If the current network performance level meets or exceeds a predetermined threshold, notification manager 210 examines “To” lists 212 and “From” lists 214 to determine if the user's user indicator appears on the lists. In an embodiment of the present invention, the “network performance level” is an aggregate measure of various network and server performance metrics, including, but not limited to: processing capacity of processors 102a-102n, memory capacity of system memories 106a-106b, and current network activity level. Also, according to an embodiment of the present invention, a “user indicator” includes, but not limited to: a username, the client's domain name (e.g., raleigh.ibm.com, endicott.ibm.com, etc.), or another other indicia that uniquely identifies the client. For example, if “raleigh.ibm.com” is preferred domain sender, notification manager 210 may enable any communication notifications from “raleigh.ibm.com” to be sent via “high priority”.

“To” lists 212 indicate a set of preferred users or contacts to which all communication notifications (e.g., presence information updates and messages) are sent via “high priority” and notification manager 210 instructs IM server program 211 to forward the communication notifications to these preferred users (i.e., “preferred recipients”) regardless of current network performance level.

“From” lists 214 indicate a set of preferred users or contacts from which all communication notifications (e.g., presence information updates and messages) are sent via “high priority” and notification manager 210 instructions IM server program 211 to forward the communication notifications from these preferred users (i.e., “preferred senders”) to regardless of current network performance level.

In an embodiment of the present invention, IM server program 211 forwards all communication notifications to their intended recipients regardless of the contents of the “To” and “From” lists 212-214 if the current network performance level is below a predetermined threshold. If the current network performance level is above a predetermined threshold, only communication notifications from preferred users from “To” lists 212 and “From” lists 214 are forwarded by IM server program 211.

According to an embodiment of the present invention, “To” lists 212 and “From” lists 214 may be defined by a variety of methods including, but not limited to, manufacturer-defined lists, system administrator-defined lists, user-defined lists (depending on the permissions allocated to the user), rule-mapping lists (e.g., executives, high-priority customers, or customers who have paid for a “high priority” classification are refreshed at a predetermined interval), or association-defined lists. An example of an association-defined list is a list of users who are associated to preferred users. The associated users are then classified as preferred users due to their association with other preferred users.

According to another embodiment of the present invention, there may not be a direct connection between gateway server 14 (FIG. 1A) and clients 18a-18n and 20a-20n. Those with skill in the art will appreciate that IM services may require a communication notification to be transferred through several nodes on a network (e.g., Internet 12) before reaching the communication notification's intended destination. Each communication notification includes header information that enables both IM server program 211 (FIG. 2A) and IM client 216 (FIG. 2B) to designate or mark each communication notification as “normal priority” or “high priority”. Marking each communication notification facilitates indicates to a forwarding network node the priority rating of each communication notification without constant references back to “To” lists 212 and “From” lists 214.

FIG. 3 is a block diagram illustrating IM contact list 302 and IM chat window 304 according to an embodiment of the present invention. IM contact list 302 and IM chat window 304 are part of IM client 216 and enable a user to interface with IM client 216 (FIG. 2B). The user can view a list of contacts and the associated user status indicate (e.g., online, offline, busy, out-to-lunch, do not disturb, etc.) for each contact in IM contact list 302. The user can send and received messages with contacts located on the contact list via chat window 304. As depicted, a “my contacts” 306 is associated with User1. “My contacts” 306 includes CEO 308a, President 308b, William 308c, Roxanna 308d, Ben 308e, and Fernando 308f. User1 can select any one of these contacts and send a message to the selected contact via chat window 304.

As previously discussed, the user may want to send a message to a recipient on IM contact list 302 whose user status indicator shows that they are “online” to ensure that the message is seen by the recipient. Lilkewise, the contacts on the user's contact list desire presence information updates from the user to make sure that any messages sent to the user are seen. Therefore, the present information must be updated as soon as any of the users on the user's IM contact list undergo a status change. However, if the network is overburdened with high traffic demands, notification manager 210 (FIG. 2A) may instruct IM server program 211 (FIG. 2A) to forward only communication notifications from preferred users on “To” lists 212 and “From” lists 214, as discussed herein in more detail in conjunction with FIG. 3.

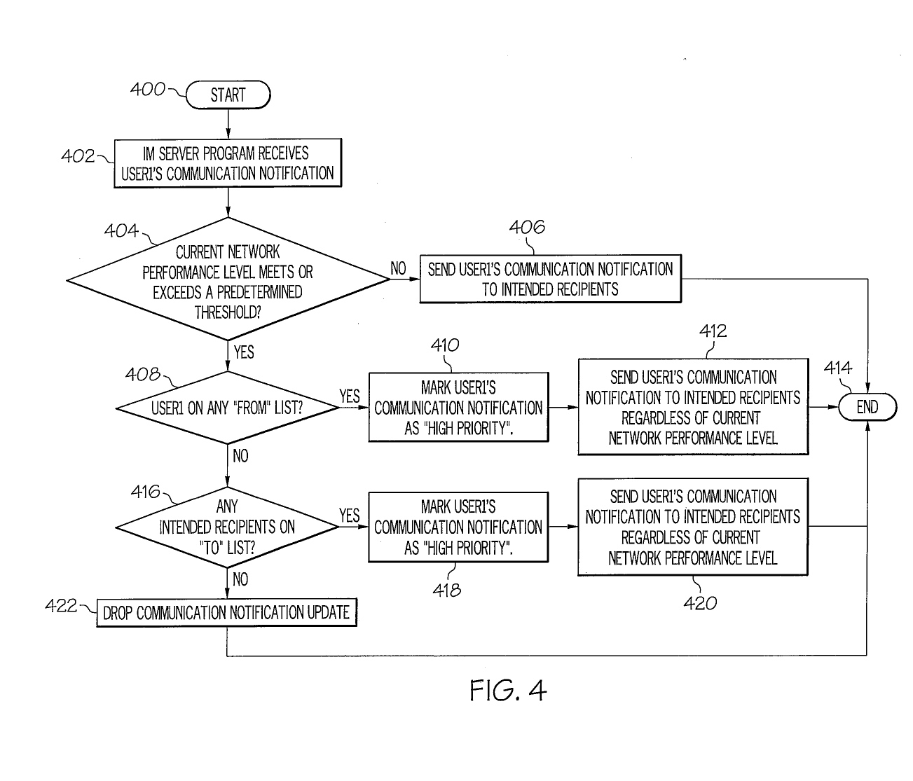

FIG. 4 is a high-level logical flowchart showing an exemplary method for providing improved communication notification forwarding on a network according to an embodiment of the present invention. For the ease of discussion, assume that “User1” is the user indicator of a first user that is utilizing IM client 216 stored in system memory 106b of client 16a. The process begins at step 400 and proceeds to step 402, which illustrates IM server program 211 receiving a communication notification from User1. As previously discussed, the communication notification may include, but is not limited to, a message targeted to at least one other user on the network and a presence information update to update User1's user status indicator. The process continues to step 404, which depicts notification manager 210 determining if the current network performance level meets or exceeds a predetermined threshold. If the current network performance level does not meet or exceed a predetermined threshold, the process proceeds to step 406, which shows IM server program 211 forwarding User1's communication notification to User1's intended recipients.

If the current network performance level meets or exceeds a predetermined threshold, the process continues to step 408, which illustrates notification manager 210 determining if User1 appears on any “From” list 214 (FIG. 2A). If User1 appears on at least one “From” list 214, notification manager 210 categorizes User1 as a “preferred sender” and instructs IM server program 211 to mark the communication notification as “high priority”. The process continues to step 410, which shows IM server program 211 marking the communication notification as a “high priority” communication notification. The process proceeds to step 412, which shows IM server program 211 forwarding User1's communication notification to the intended recipients regardless of current network performance level. The process ends, as show in step 414.

Returning to step 408, if notification manager 210 determines that User1 does not appear on any “From” list 214, the process continues to step 416, which depicts notification manager 210 determining if any of the intended recipients of User1's communication notification appear on any “To” lists 212. If notification manager 210 determines if any of the intended recipients of User1's communication notification appear on at least one “To” list 212, notification manager 210 categorizes the identified recipients found on “To” lists 212 to be “preferred recipients” and instructs PA server program 211 to mark the communication notification as “high priority”. The process continues to step 418, which illustrates PA server 211 marking the communication notification as a “high priority” communication notification. The process continues to step 420, which depicts PA server 211 forwarding the communication notification to the intended preferred recipients regardless of current network performance level. The process ends, as shown in step 414.

Returning to step 416, if none of the intended recipients of User1's communication notification appear on any “To” lists 212, the process continues to step 422, which illustrates PA server program 211 dropping User1's communication notification. In an alternate embodiment, PA server program 211 and intervening forwarding nodes on the network will have a queue to buffer communication notifications not designed as “high priority” until the current network performance level falls below a predetermined threshold. Then, IM server program 211 and intervening forwarding nodes can forward any non-“high priority” communication notifications after the current network performance level falls below a predetermined threshold. The process ends, as shown in step 414.

As disclosed, the present invention includes a system and method for improved communication notification forwarding on a network. An instant messaging (IM) server program receives at least one communication notification from a first client among a collection of clients on a network, wherein the at least one communication notification is targeted to a second client among the collection of clients. A notification manager compares a current network performance level to a predetermined threshold. In response to said comparing the current network performance level to the predetermined threshold, the notification manager parses a first list to determine if a first user indicator associated with said first client is present on the first list, wherein the first list indicates a first collection of user indicators of clients from which communication notifications are to be forwarded as high priority communication notifications. If the user indicator associated with the first client is present on the first list, the IM server program forwards the at least one communication notification as a high priority communication notification to said second client.

It should be understood that at least some aspects of the present invention may alternately be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to random access memory (RAM), and communication media, such as computer networks and telephone networks, including Ethernet, the Internet, wireless networks, and like networks. It should be understood, therefore, that such signal-bearing media, when carrying or encoding computer-readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention.

What is claimed is:

1. A computer-implementable method for improved communication notification forwarding on a network, said computer-implementable method comprising:
receiving at least one communication notification from a first client among a plurality of clients on a network, wherein said at least one communication notification is targeted to a second client among said plurality of clients;
comparing a current network performance level to a predetermined threshold;
in response to said comparing said current network performance level to said predetermined threshold, parsing a first list to determine if a first user indicator associated with said first client is present on said first list, wherein said first list indicates a first plurality of user indicators of clients from which communication notifications are to be forwarded as high priority communication notifications; and
if said user indicator associated with said first client is present on said first list, forwarding said at least one communication notification as a high priority communication notification to said second client.

2. The computer-implementable method according to claim 1, further comprising:
in response to said comparing said current network performance level to said predetermined threshold, parsing a second list to determine if a second user indicator associated with said second client is present on said second list, wherein said second list indicates a second plurality of user indicators of clients to which communication notifications are to be forwarded as high priority communication notifications; and
if said user indicator associated with said second client is present on said second list, forwarding said at least one communication notification as a high priority communication notification to said second client.

3. The computer-implementable method according to claim 1, wherein said at least one communication notification is a presence information update.

4. The computer-implementable method according to claim 1, wherein said at least one communication notification is an instant messaging (IM) message.

5. The computer-implementable method according to claim 1, wherein said user indicator is a username of said first client among said plurality of clients.

6. The computer-implementable method according to claim 1, wherein said user indicator is a domain name.

7. A system for improved communication notification forwarding on a network, said system comprising:
at least one processor;
a data bus coupled to said at least one processor;
a computer-usable medium embodying computer program code, the computer-usable medium being coupled to the data bus, the computer program code comprising instructions executable by said at least one processor and configured for:
receiving at least one communication notification from a first client among a plurality of clients on a network, wherein said at least one communication notification is targeted to a second client among said plurality of clients;
comparing a current network performance level to a predetermined threshold;
in response to said comparing said current network performance level to said predetermined threshold, parsing a first list to determine if a first user indicator associated with said first client is present on said first list, wherein said first list indicates a first plurality of user indicators of clients from which communication notifications are to be forwarded as high priority communication notifications; and
if said user indicator associated with said first client is present on said first list, forwarding said at least one communication notification as a high priority communication notification to said second client.

8. The system according to claim 7, further comprising instructions configured for:
in response to said comparing said current network performance level to said predetermined threshold, parsing a second list to determine if a second user indicator associated with said second client is present on said second list, wherein said second list indicates a second plurality of user indicators of clients to which communication notifications are to be forwarded as high priority communication notifications; and
if said user indicator associated with said second client is present on said second list, forwarding said at least one communication notification as a high priority communication notification to said second client.

9. The system according to claim 7, wherein said at least one communication notification is a presence information update.

10. The system according to claim 7, wherein said at least one communication notification is an instant messaging (IM) message.

11. The system according to claim 7, wherein said user indicator is a username of said first client among said plurality of clients.

12. The system according to claim 7, wherein said user indicator is a domain name.

13. A computer-usable medium embodying computer program code, said computer program code comprising computer executable instructions configured for:
receiving at least one communication notification from a first client among a plurality of clients on a network, wherein said at least one communication notification is targeted to a second client among said plurality of clients;
comparing a current network performance level to a predetermined threshold;
in response to said comparing said current network performance level to said predetermined threshold, parsing a first list to determine if a first user indicator associated with said first client is present on said first list, wherein said first list indicates a first plurality of user indicators of clients from which communication notifications are to be forwarded as high priority communication notifications; and
if said user indicator associated with said first client is present on said first list, forwarding said at least one communication notification as a high priority communication notification to said second client.

14. The computer-usable medium according to claim 13, wherein said embodied computer program code further comprises computer executable instructions configured for:
in response to said comparing said current network performance level to said predetermined threshold, parsing a second list to determine if a second user indicator associated with said second client is present on said second list, wherein said second list indicates a second plurality of user indicators of clients to which communication notifications are to be forwarded as high priority communication notifications; and
if said user indicator associated with said second client is present on said second list, forwarding said at least one communication notification as a high priority communication notification to said second client.

15. The computer-usable medium according to claim 13, wherein said at least one communication notification is a presence information update.

16. The computer-usable medium according to claim 13, wherein said at least one communication notification is an instant messaging (IM) message.

17. The computer-usable medium according to claim 13, wherein said user indicator is a username of said first client among said plurality of clients.

18. The computer-usable medium according to claim 13, wherein said user indicator is a domain name.
